(19) United States
(12) Patent Application Publication
(10) Pub. No.: US 2008/0261519 A1
(43) Pub. Date: Oct. 23, 2008

(54) Dual cancellation loop wireless repeater

(75) Inventors: Anthony DeMarco, Newport Beach, CA (US); Daniel Ray Ash, San Juan Capistrano, CA (US); Tareq Adel Risheq, Laguna Niguel, CA (US)

Correspondence Address: FISH & ASSOCIATES, PC;ROBERT D. FISH, 2603 Main Street, Suite 1050, Irvine, CA, 92614-6232, US

(73) Assignee: CELLYNX, INC., Laguna Niguel, CA (US)

(21) Appl. No.: 12/106,468

(22) Filed: Apr. 21, 2008

Related U.S. Application Data
(63) Continuation-in-part of application No. 11/625,331, filed on Jan. 21, 2007.
(60) Provisional application No. 61/045,662, filed on Apr. 17, 2008.
(60) Provisional application No. 60/767,313, filed on Mar. 16, 2006.
(60) Provisional application No. 60/803,007, filed on May 23, 2006.
(60) Provisional application No. 60/806,103, filed on Jun. 29, 2006.
(60) Provisional application No. 60/807,436, filed on Jul. 14, 2006.

(51) Int. Cl. H04B 3/36

(52) U.S. Cl. 455/7

(57) ABSTRACT

A wireless repeater comprises dual cancellation loops. The wireless repeater includes an active cancellation loop and a passive cancellation loops. The active cancellation loops reduces an environmentally induced signal component from a receive signal entering the repeater's amplifier. The passive cancellation loop reduces leaked signal component from the received signal.

This application claims the benefit of U.S. provisional application 61/045,662 filed on Apr. 17, 2008, and is also a continuation in part of U.S. patent application Ser. No. 11/625,331, now published as U.S. patent publication 2007/0218951, filed on Jan. 21, 2007, which claims the benefit of priority to U.S. provisional application 60/767,313 filed Mar. 16, 2006; U.S. provisional application 60/803,007 filed May 23, 2006; U.S. provisional application 60/806,103 filed Jun. 29, 2006; and U.S. provisional application 60/807,436 filed on Jul. 14, 2006. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is repeater technologies.

### BACKGROUND

Wireless repeaters include two antennas coupled through one or more amplifiers. A receiving antenna receives signals which are passed through an amplifier to the transmitting antenna for transmission to remote devices. In most cases the repeaters receive and transmit on nearby frequencies, if not the same frequency. Consequently, the receive signal can include interference from the transmitter or from other environmentally induced interference (e.g., a radiated coupled signal).

Great care must be taken to ensure the placement of the two antennas is such that the gain in a bi-directional amplifier is less than the isolation measured in dB between the two antennas. Typically repeaters have antennas that are separated apart by a large distance, e.g., more than ten meters, to reduce signals received from the transmitting antenna. Such configurations are useful for large installations, a repeater tower for example.

For typical repeater installations the vertical and horizontal spacing of the two antennas is significant in that it requires the physical mounting of the antennas in different locations and the routing of feeder cables to complete the circuit to the bi-directional amplifier. It is generally accepted that the installation of traditional repeaters is beyond what could be reasonably expected from the average consumer in a home or office environment.

Repeaters targeting smaller installations employ various forms of active cancellation circuitry to reduce undesirable, dynamic components from the received signal. Examples of dynamic signal components include environmentally induces signal, radiate coupled signals from the transmitter, or other signal sources that vary with time.

Example repeaters having active cancellation loops include those described by U.S. Pat. No. 6,640,110 to Shapira et al. or described by parent application U.S. patent publication 2007/0218951 to Risheq et al. Shapira describes a repeater having multiple active cancellation loops that include a signal cancellation and a distortion cancellation loop. Risheq describes a cell phone booster incorporating an active stability control network to compensate for undesirable signal components. In both cases the repeaters adapt to conditions in real-time.

Current trends in the wireless repeater market continue to focus on creating wireless repeaters ever more complex and subtle active cancellation loops. Interestingly, there has been little effort placed on incorporating passive cancellation loops that cancel a leaked signal component stemming from the properties of the wireless repeater itself.

Each wireless repeater has a set of properties including physical properties or electrical properties that can result in various leaked signals due to a feedback path in the repeater design. The lead signal can also enter the amplifier. However, the properties, and hence the leak signal, remain static. Furthermore, the leak signal component of the receive signal entering the amplifier can be reduced using a passive cancellation loop. The passive loop can include one or more static configurable parameters used to describe the leak where the configuration parameters are related to the repeater's design or physical form.

Thus, there is still a need for wireless repeater that provides both active cancellation and passive cancellation of interfering signals.

### SUMMARY OF THE INVENTION

The present invention provides apparatus, systems and methods in which a wireless repeater comprises an active cancellation loop and a passive cancellation loop. The active loop reduces environmentally induced signals within a received signal. The passive loop reduces leaked signals within the received signal.

In one aspect, the active and passive cancellation loops allow for placing the antennas of the repeater within close proximity (e.g., spaced apart less than one meter from each other). Preferably, the antennas can be spaced apart by less than 30 centimeters and more preferably less than three centimeters.

In yet another aspect, the passive cancellation loop comprises one or more configurable parameters that can be used to alter the cancellation of a leaked signal. The configurable parameters can be adjusted through one or more interfaces at the time of manufacture of the repeater, in the field, while active, or other relevant times.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a wireless repeater having dual cancellation loops.

FIG. 2 is a schematic of a wireless repeater of FIG. 1 detailing control elements of a passive cancellation loop.

### DETAILED DESCRIPTION

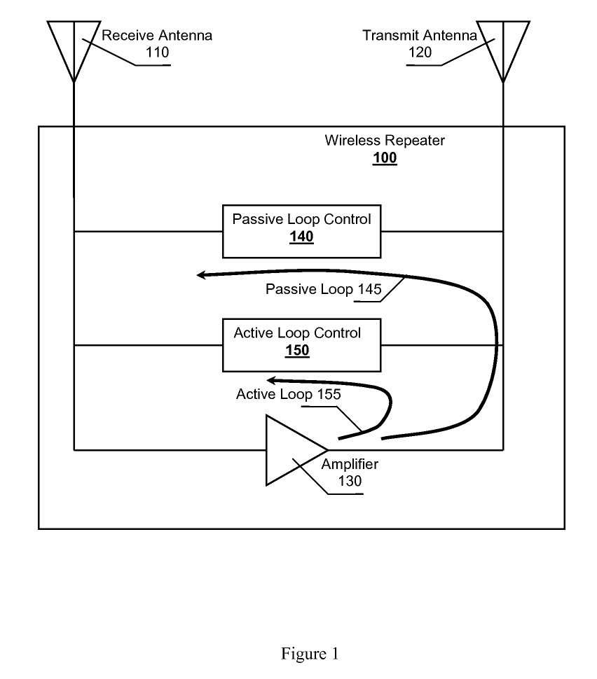

In FIG. 1, wireless repeater 100 comprises receiving antenna 110, transmit antenna 120, and dual cancellation loops: active cancellation loop 145 and passive cancellation loop 155. Active loop 155 employs active loop control 150 to reduce a dynamic environmentally induced signal component entering amplifier 130, preferably a bi-directional amplifier. Passive loop 145 includes passive loop control 140 which reduces leak signal components entering amplifier 130.

The inventive subject matter can be applied to many different forms of wireless repeater 100. Contemplated embodiments comprise repeaters for various wireless systems including cell phones (e.g., GSM, CDMA, TDMA, etc. . . . ), RFID, 802.11, 802.16 (e.g., WiMax), 802.15, 802.20, wireless USB, Bluetooth, UWB, or other wireless communication system.

One should note that each physical antenna preferably can operate as a both a transmitting and receiving antenna. The examples provide within this document should not be considered limiting with respect to the antennas. Rather the use of “receive” and “transmit” represent functional roles that a physical antenna can perform.

A cancellation loop comprises an electrical feedback loop with associated electronics to reduce a component of the signal entering amplifier 130. Preferably, each loop comprises sufficient control elements, represented by passive loop control 140 and active loop control 150, to generate a signal representing the inverse of an undesirable component of the signal entering amplifier 130. In a preferred embodiment, one or more inverse signals from the cancellation loops are combined with a received signal originating from receive antenna.

Although a preferred embodiment employs a dual loop system, it should be appreciated that wireless repeater 100 could comprise multiple cancellation loops while remaining within the scope of the inventive subject matter.

Active cancellation loop 155 preferably comprises a design to address environmentally induced signals that change dynamically, in real-time through automatic update of one or more loop configuration parameters. As used herein, “active” means that the loop adapts itself dynamically, in real-time. Active loop control 150 detects environmental conditions including radiated coupled signals, signal reflections, or other dynamic sources of undesirable signals. An acceptable active loop control includes the active stability control network taught within parent application U.S. patent publication 2007/0218951. As conditions change in real-time causing environmentally induced signals, active cancellation loop 155 generates one or more inverse signals. When the inverse signals are combined with the received signal, the signal component from the environmentally induced signal is reduced before entering amplifier 130.

In a preferred embodiment, passive cancellation loop 145 operates to reduce, or even remove, a static signal component from the received signal entering amplifier 130. As used herein, “passive” means that the configuration parameters of the loop remain substantially static over time. Preferred static signal components include a leak signal component due to a signal feedback path within the design or physical form of wireless router 100 and that remains relatively constant over time. Passive loop control 140 comprises suitable control elements to generate an inverse signal representing the leak signal component. When combined with the received signal, the leak signal component is reduced as the received signal enters amplifier 130. Passive loop control 140 is described in more detail below.

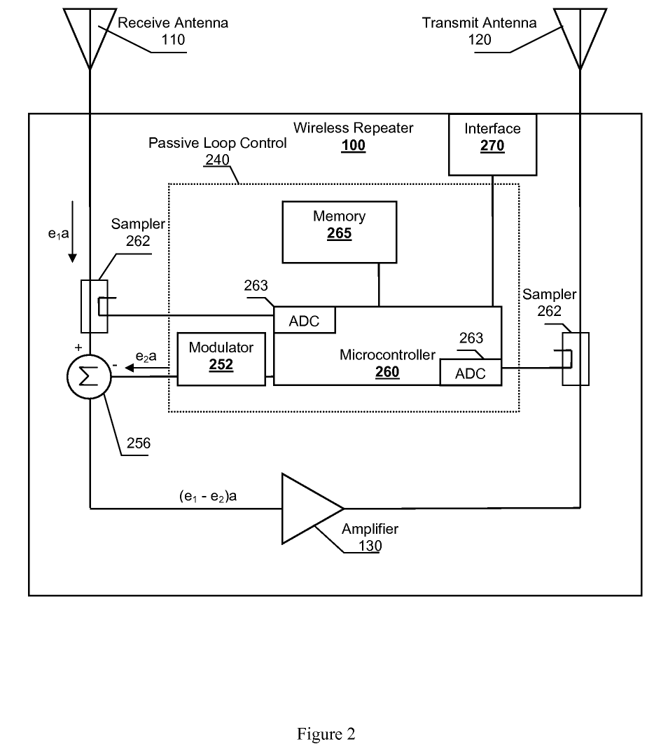

In FIG. 2, passive loop control 240 within repeater 100 preferably comprises several control elements including microcontroller 260, memory 265, or modulator 252. The control elements operate to generate signal e₂a representing an inverse signal component stemming from a leak signal.

In a preferred embodiment, memory 265 stores information relating to generating the leak signal component, e₂a. A preferred memory comprises a persistent memory that retains the information over the power cycling of repeater 100. Example persistent memories include flash, NVRAM, magnetic storage (e.g., a hard drive), or other non-volatile storage.

The signal generation information includes one or more configurable parameters, or instructions for microprocessor 260. The configuration parameters represent various parameters that can be used by the instructions executing on microcontroller 260 to generating leak signal e₂a. Contemplated configuration parameters include frequency, phase, in-phase (I) or quadrature (Q) phase signals, delay, amplitude, gain, or other signal configuration parameters.

One should appreciate that a leak signal represents a static signal with respect to its configuration parameters. Simply put, the configuration parameters of the leak signal do not vary appreciably over time. However, it is contemplated that the leak signal has time varying components. For example, the amplitude of signal e₂a could vary in time according to a static frequency, or the frequency of signal e₂a could vary according to a static modulation.

Although leak signal e₂a's configuration parameters are expected to remain static over time, it is also contemplated such parameters can be upgraded or otherwise updated. The configuration parameters can preferably be updated through interface 270 which provides a communication path external to repeater 100. Interface 270 can include a physical interface (wired or wireless) or a logical interface. Example physical interfaces include Ethernet, USB, serial (e.g., RS-232), Firewire, Bluetooth, or other physical interface. Interface 270 can also comprise a logical interface accessed over a physical interface. For example, configuration parameters could be externally accessed through logical interfaces including an API (e.g., web service), web page, Telnet, command line interface, protocols, or other logical interface. It is also contemplated that the configuration parameters can be updated when repeater 100 receives a firmware upgrade.

Microcontroller 260 accepts one or more inputs to generate leak signal e₂a. Preferably, inputs primarily include configuration parameters stored in memory 260. However, it is also contemplated that microcontroller 260 can optionally accept inputs through analog-to-digital converters (ADC) 263 from one or more RF samplers 262 that detect conditions on receive antenna 110 or transmit antenna 120. Although, ADCs 263 are shown as part of microcontroller 260, it should be noted that ADCs 260 can be external to microcontroller 260.

Microcontroller 260 generates signal e₂a from the various inputs through known techniques. For example, microcontroller 260 can optionally provide one or more inputs to modulator 252 that generates signal e₂a. Contemplated modulator inputs include an in-phase signal (I) or a quadrature phase signal (Q). In some embodiments, modulator 252 comprises a vector modulator.

Signal e₁a represents a received signal that would ordinarily enter amplifier without modification. However, signal combiner 256 combines signal e₁a with e₂a to generate the resulting signal (e₁-e₂)a that enters amplifier 260. The resulting signal has the leak signal component reduced by the inverse signal generated, e₂a, by passive loop control 240.

Although this document presents an example where passive cancellation loop represents a separate loop from an active cancellation loop, it should be noted that both loops can be combined to form a single loop. In such an approach, the algorithms to generate an inverse leak signal can be combined with the algorithms to generate an inverse of environmentally induced signals to yield signal e₂a which can then be combined with received signal e₁a as shown.

In a preferred embodiment, repeater 100 provides for configuring its passive cancellation loop by storing the loop's configuration parameters as previously discussed. In one embodiment, the configuration parameters can be uploaded to memory 265 before shipping repeater 100 to distributors or customers. The proper values of the configuration parameters can be determined through measuring the leak signal while repeater 100 operates within an RF-free environment, possible within a Faraday cage. In addition, the proper values of the parameters can be determined by tuning the parameters to achieved optimized performance. Regardless, of the method used to determine the parameters, once a desirable set of parameters are found they can be uploaded through interface 270.

In yet other embodiments, one can also update the passive cancellation loop's configuration parameters in the field, possibly even after installation or even when repeater 100 remains active. For example, a consumer could install repeater 100 in their home and then periodically update the configuration parameters through interface 270. Alternatively, repeater 100 can automatically retrieve a configuration file via interface 270, possibly an XML file, having updated configuration parameters.

Providing a repeater that supports updating configuration parameters offers several advantages over existing systems. For example, such an approach provides for updating configuration parameters without requiring a complete firmware upgrade or shutting down the repeater. Additionally, the repeater's cancellation loops are robust across re-designs, possibly resulting from a cost reduction, where the physical form of the repeater has changed. When a repeater is redesigned, any leak signal will also likely change. Once a redesign is complete, new configuration parameters can be determined and uploaded, again without requiring a complete firmware change.

Wireless repeaters having both active and passive cancellation loops allow for fine grained control over undesirable signal components entering the repeater's amplifier while also allowing for realistic antenna isolation when the antennas are placed in close proximity to each other, irrespective of a gain associated with the amplifier. In a preferred embodiment, the antennas are separated by less than about 30 centimeters and yet more preferably less than about three centimeters. Such repeaters represent ideal products that can be deployed or installed by consumers lacking technical expertise.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A wireless repeater having a receiving antenna and a transmitting antenna, the repeater comprising:
an amplifier coupling the receiving antenna and the transmitting antenna and that receives a received signal from the receiving antenna;
an active cancellation loop to reduce an environmentally induced signal component from the received signal entering the amplifier; and
a passive cancellation loop to reduce a leak signal component from the received signal entering the amplifier.

2. The repeater of claim 1, wherein the amplifier comprises a bi-directional amplifier.

3. The repeater of claim 1, wherein the active cancellation loop and the passive cancellation loop are the same loop.

4. The repeater of claim 1, wherein the receiving antenna and the transmitting antenna are separated by less than approximately 30 centimeters.

5. The repeater of claim 5, wherein the receive antenna and the transmitting antenna are spaced apart by less than approximately three centimeters.

6. The repeater of claim 1, wherein the receive antenna and the transmitting antenna are positioned relative to each other irrespective of a gain of the repeater.

7. The repeater of claim 1, wherein the active cancellation loop is configured to stabilize a gain across the amplifier in real-time.

8. The repeater of claim 7, wherein the active cancellation loop is further configured to reduce oscillations across the amplifier.

9. The repeater of claim 1, wherein the active cancellation loop is configured to reduce a loop back gain.

10. The repeater of claim 1, wherein the repeater is configured to provide at least 60 dB of stable gain.

11. The repeater of claim 1, wherein the repeater is configured to provide at least 45 dB of signal isolation between the receiving and the transmitting antennas.

12. The repeater of claim 1, further comprising an interface to adjust the passive cancellation loop's parameters.

13. The repeater of claim 1, wherein the amplifier is configured to be operable across multiple bands.

14. The repeater of claim 13, wherein the receive antenna and the transmitting antenna comprise phased antennas.

15. The repeater of claim 1, wherein the amplifier is adapted to amplify a cell phone signal.

16. The repeater of claim 1, wherein the repeater is configured to be portable when active.

17. The repeater of claim 16, wherein the repeater is disposed within a mobile platform.

18. The repeater of claim 1, further comprising a Bluetooth interface.

19. The repeater of claim 1, wherein the receiving and the transmitting antennas are configured to be responsive to signals generated from at least one of the follow: an RFID tag, a cell phone, a WiMax router, and a Bluetooth device.
